(19) United States
(12) Patent Application Publication
(10) Pub. No.: US 2025/0077727 A1
(43) Pub. Date: Mar. 6, 2025

(54) DESIGN-SUPPORT DEVICE, DESIGN-SUPPORT METHOD, AND RECORDING MEDIUM

(71) Applicant: ASICS CORPORATION, Kobe-shi (JP)

(72) Inventors: Yuya KOZUKA, Kobe-shi (JP); Shinnosuke KODAIRA, Kobe-shi (JP); Midori IWAKIRI, Kobe-shi (JP)

(21) Appl. No.: 18/820,956

(22) Filed: Aug. 30, 2024

(30) Foreign Application Priority Data
Sep. 4, 2023 (JP) 2023-142790

(51) Int. Cl. G06F 30/17; G06T 7/50; G06T 19/20

(52) U.S. Cl. CPC G06F 30/17; G06T 7/50; G06T 19/20; G06T 2200/04; G06T 2219/2021

(57) ABSTRACT

A design-support device 1 is a design-support device 1 that supports creation of design data to be input to a manufacturing device 2 that manufactures a three-dimensional formed object. The design-support device 1 includes an input unit that receives shape data 200 on the formed object and device information 100 on the manufacturing device 2, a processing unit that identifies, in the shape data 200, based on the device information 100, a first region of the formed object unmanufacturable by the manufacturing device 2 and creates the design data in which a shape pattern of the first region is modified, a storage unit that stores a manufacturable modification pattern, and an output unit that outputs the design data modified by the processing unit. The processing unit creates the design data by changing the shape pattern of the first region to the modification pattern.

### CROSS-REFERENCE TO RELATED APPLICATION

This application claims priority to Japanese Patent Application No. 2023-142790, filed on Sep. 4, 2023, the disclosures of which are incorporated herein by reference in their entirety.

### BACKGROUND

### Technical Field

The present disclosure relates to a design-support device, a design-support method, and a recording medium.

### Background Information

Manufacturing processes that enable diversified small-quantity production have been developed to suit customer (user) preferences. For example, Japanese Unexamined Patent Application Publication No. 2022-083981 discloses, as an intuitive customization system, a system that connects, via the Internet, a server, a display device, and an interface unit with a factory or workshop for manufacturing products (e.g., shoes) and allows production and purchase of products designed to suit customer (user) preferences. Furthermore, manufacturing using a mold is unsuitable for diversified small-quantity production, and it is preferable to use a manufacturing device that manufactures a three-dimensional formed object, such as a three-dimensional printing device.

### SUMMARY

However, a formed object having a certain shape unmanufacturable by a manufacturing device that manufactures a three-dimensional formed object, depending on a formation method of the manufacturing device, and if shape data on a product (three-dimensional formed object) designed to suit user preferences is directly input to the manufacturing device, manufacturing failure may occur. Furthermore, for the manufacturing device to manufacture a formed object based on such shape data, reworking of the shape data in advance by a designer who is familiar with the formation method is required to modify the shape data to design data, thus involving complicated work.

The present disclosure has been made to solve such problems, and an object of the present disclosure is to provide a design-support device, a design-support method, and a recording medium that are capable of outputting design data that enables a designed three-dimensional formed object to be manufactured by a manufacturing device that manufactures a three-dimensional formed object.

A design-support device according to an aspect of the present disclosure is a design-support device that supports creation of design data to be input to a manufacturing device that manufactures a three-dimensional formed object. The design-support device includes: an input unit that receives shape data on the formed object and device information on the manufacturing device; a processing unit that identifies, in the shape data, based on the device information, a first region of the formed object unmanufacturable by the manufacturing device and creates the design data in which a shape pattern of the first region is modified, a storage unit that stores a manufacturable modification pattern, and an output unit that outputs the design data modified by the processing unit. The processing unit creates the design data by changing the shape pattern of the first region to the modification pattern.

A design-support method according to an aspect of the present disclosure is a design-support method of supporting creation of design data to be input to a manufacturing device that manufactures a three-dimensional formed object. The design-support method includes: receiving shape data on the formed object and device information on the manufacturing device; identifying, in the shape data, based on the device information, a first region of the formed object unmanufacturable by the manufacturing device; creating the design data by changing, to a manufacturable modification pattern, the shape data on the first region identified; and outputting the design data created.

A recording medium according to an aspect of the present disclosure is a non-transitory recording medium recording a program executed by a processing unit of a design-support device that supports creation of design data to be input to a manufacturing device that manufactures a three-dimensional formed object. The program includes: receiving, by an input unit, shape data on the formed object and device information on the manufacturing device; identifying, in the shape data, based on the device information, a first region of the formed object unmanufacturable by the manufacturing device; creating the design data by changing, to a manufacturable modification pattern stored in a storage unit, the shape data on the first region identified; and outputting, from an output unit, the design data created.

The present disclosure makes it possible to automatically create design data that enables a designed three-dimensional formed object to be manufactured, without reworking of shape data by a designer.

### BRIEF DESCRIPTION OF THE DRAWINGS

FIG. 1 is a schematic diagram of a design-support device according to Embodiment 1.

FIG. 2 is a block diagram illustrating a configuration of the design-support device according to Embodiment 1.

FIGS. 3A-3C are each a schematic diagram illustrating examples of shapes unmanufacturable by a certain formation method.

FIGS. 4A-4C are each a schematic diagram illustrating examples of shapes unmanufacturable by another formation method.

FIG. 5 is a flowchart illustrating a process performed by the design-support device according to Embodiment 1.

FIG. 6 is a schematic diagram illustrating the process performed by the design-support device according to Embodiment 1.

FIG. 7 is a schematic diagram illustrating a modification pattern.

FIG. 8 is a schematic diagram illustrating a process performed by a design-support device according to Embodiment 2.

FIG. 9 is a schematic diagram illustrating a process performed by a design-support device according to a modification.

FIGS. 10A and 10B are each a schematic diagram illustrating other methods of identifying an unmanufacturable shape.

### DETAILED DESCRIPTION

An embodiment of a design-support device and a design-support method will be described below with reference to the drawings. In the following description, the same components are denoted by the same reference numerals. The same applies to the names and functions of those components. Therefore, detailed description of those components is not repeated. The following will describe an example of a design-support device and a design-support method that support designing of a footwear item, which is an item worn by a user; however, an object to be designed is not limited to a footwear item, and may be any three-dimensional formed object manufacturable by a manufacturing device. The design-support device and the design-support method are similarly applicable to support, for example, designing of clothes, gloves, helmets, sporting goods, or the like.

### Embodiment 1

### Configuration of Design-Support Device

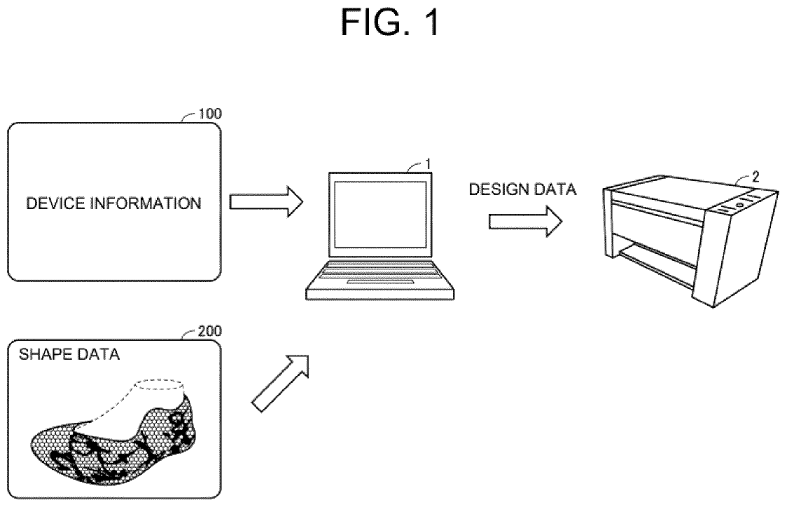

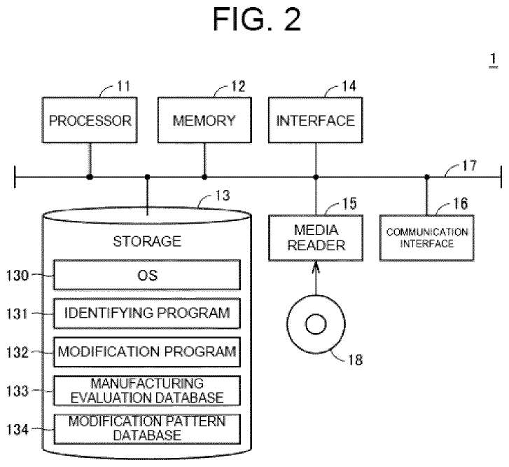

FIG. 1 is a schematic diagram of a design-support device 1 according to an embodiment. FIG. 2 is a block diagram illustrating a configuration of the design-support device 1 according to the embodiment. For example, in a store such as a shoe store, an event site, or the like, in some cases, a custom-made footwear item conforming to the shape of a foot of an individual user is produced. In such a case, a footwear item may be designed to suit user preferences, produced by a manufacturing device 2 that manufactures a three-dimensional formed object, such as a three-dimensional printing device, and provided to the user. The design-support device 1 illustrated in FIG. 1 receives device information 100 including information on a formation method of the manufacturing device 2 and the like and footwear item shape data 200 on a footwear item, and outputs, to the manufacturing device 2, design data that enables the footwear item to be produced by the manufacturing device 2. The shape data 200 is, for example, computer-aided design (CAD) data such as line data or mesh data. The design data may be any data that can be input to the manufacturing device 2, and is, for example, stereolithography (STL) data that can be processed by the manufacturing device 2.

In the above description, the design-support device 1 is assumed to design, using a separate design device, the shape data 200 on a footwear item designed to suit user preferences and to receive the shape data 200 from the design device. However, the design-support device 1 may execute a design program to design the shape data 200 on a footwear item designed to suit user preferences. Furthermore, instead of receiving the device information 100 including information on the formation method of the manufacturing device 2 and the like, the design-support device 1 may perform a process of receiving the device information 100 by reading, from a storage, information on the formation method of the manufacturing device 2 and the like, in response to input of the product name, product number, or the like of the manufacturing device 2.

As illustrated in FIG. 2, the design-support device 1 includes a processor 11, a memory 12, a storage 13, an interface 14, a media reader 15, and a communication interface 16. These components are connected via a processor bus 17.

The processor 11 is an example of a “processing unit”. The processor 11 is a computer that reads a program (e.g., an operating system (OS) 130, an identifying program 131, and a modification program 132) stored in the storage 13 and develops and executes the read program in the memory 12. The processor 11 is composed of, for example, a central processing unit (CPU), a field programmable gate array (FPGA), a graphics processing unit (GPU), a multi-processing unit (MPU), or the like. The processor 11 may be composed of processing circuitry.

The memory 12 is composed of a volatile memory such as a Dynamic Random Access Memory (DRAM) or a Static Random Access Memory (SRAM), a non-volatile memory such as a Read Only Memory (ROM) or a flash memory, or the like.

The storage 13 is composed of, for example, a non-volatile storage device such as a Hard Disk Drive (HDD) or a Solid State Drive (SSD). The storage 13 stores data such as a manufacturing evaluation database 133 and a modification pattern database 134, in addition to programs such as the OS 130, the identifying program 131, and the modification program 132.

The identifying program 131 is a program for identifying a region unmanufacturable by the manufacturing device 2 in the footwear item shape data 200. In the present disclosure, the region unmanufacturable by the manufacturing device 2 includes a region with manufacturing difficulty above a predetermined level. The modification program 132 is a program for creating design data by changing, to a manufacturable modification pattern manufacturable by the manufacturing device 2, the shape pattern of the unmanufacturable region identified using the identifying program 131. A footwear item is an example of the “formed object” in the claims.

The interface 14 is an example of an “input unit” or an “output unit”. For example, the interface 14 is configured to receive, as the “input unit”, input from a keyboard, a mouse, a touch device, or the like to the design-support device 1 and to output, as the “output unit”, modified design data to a display or the like.

The media reader 15 accepts a storage medium such as a removable disk 18, and acquires a program or data stored in the removable disk 18 or the like. A storage medium such as the removable disk 18 may store programs such as the identifying program 131 and the modification program 132.

The communication interface 16 is an example of the “input unit” or the “output unit”. The communication interface 16 performs transmission and reception of data with other devices via wired or wireless communication. For example, the communication interface 16 receives, as the “input unit”, input of the shape data 200 from a separate design device, and outputs, as the “output unit”, design data to the manufacturing device 2. Furthermore, the communication interface 16 may be used to download the identifying program 131 and the modification program 132 to the storage 13.

The design-support device 1 described below executes the identifying program 131 and the modification program 132 to create, from the shape data 200, design data that enables a formed object to be manufactured by the manufacturing device 2. However, the design-support device 1 may read the shape data 200 stored in the removable disk 18 by the media reader 15.

### Manufacturing Condition of Manufacturing Device

Next, a manufacturing condition of the manufacturing device 2 will be described. The manufacturing device 2 is a device that manufactures a three-dimensional formed object, and examples of the manufacturing device include a three-dimensional printing device, a numerically controlled (NC) machine tool, and a machining center. These devices use different formation methods, and thus have different manufacturing conditions such as shapes easy to manufacture and unmanufacturable shapes, depending on the formation methods. Specifically, an unmanufacturable manufacturing condition under which no formed object is manufacturable will be described in detail for each formation method.

In the present disclosure, the term “unmanufacturable shapes” includes not only shapes unmanufacturable by the manufacturing device 2 due to the limitations of a formation method, but also includes various shapes that hinder the provision of products to users, such as shapes that are manufacturable by the manufacturing device 2 but cause poor functioning and shapes that are manufacturable by the manufacturing device 2 but require additional work leading to high manufacturing cost.

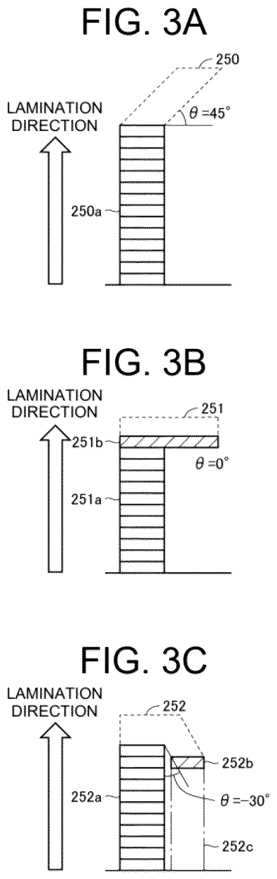

FIGS. 3A-3C are each a schematic diagram illustrating examples of shapes unmanufacturable by a certain formation method. The examples in FIGS. 3A-3C illustrate shapes unmanufacturable by the manufacturing device 2 of fused deposition modeling (FDM). The FDM manufacturing device 2 forms a three-dimensional formed object by melting an ABS resin, a PLA resin, or the like at high temperature and ejecting the melted resin from a nozzle so that the resin is deposited. Thus, as illustrated in FIG. 3A, a formed object 250 having a shape inclined at 45 degrees from the direction perpendicular to the lamination direction is manufacturable by the FDM manufacturing device 2 through lamination of a resin 250a in the lamination direction.

However, as illustrated in FIG. 3B, in a formed object 251 having a shape inclined at 0 degrees from the direction perpendicular to the lamination direction, a portion 251b of the formed object 251 that protrudes to the right in FIG. 3B is unmanufacturable by the FDM manufacturing device 2 even through lamination of a resin 251a in the lamination direction. Furthermore, as illustrated in FIG. 3C, in a formed object 252 having a shape inclined at −30 degrees from the direction perpendicular to the lamination direction, an inclined portion 252b of the formed object 252 is unmanufacturable by the FDM manufacturing device 2 even through lamination of a resin 252a in the lamination direction. In order to manufacture the inclined portion 252b, it is necessary to prepare a support member 252c separately and laminate the resin 252a on the support member 252c in the lamination direction.

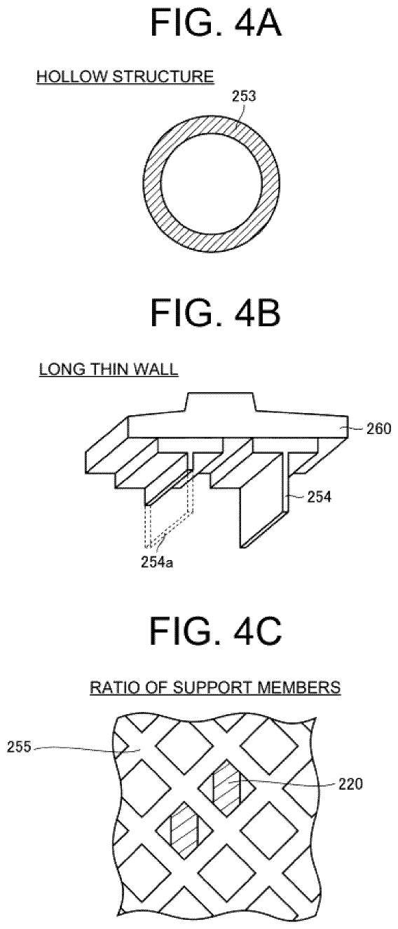

Next, FIGS. 4A-4C are each a schematic diagram illustrating examples of shapes unmanufacturable by another formation method. The examples in FIGS. 4A-4C illustrate shapes unmanufacturable by the manufacturing device 2 of stereolithography (in particular, digital light processing (DLP). The DLP manufacturing device 2 forms a three-dimensional formed object by irradiating a liquid resin with ultraviolet (UV) light so that the liquid resin is cured. In addition to the shapes illustrated in FIGS. 3A-3C, a formed object 253 having a hollow structure illustrated in FIG. 4A is unmanufacturable by the DLP manufacturing device 2.

Furthermore, as illustrated in FIG. 4B, a formed object 254 having a long thin wall shape is also unmanufacturable by the DLP manufacturing device 2 because a portion 254a of the formed object 254 falls off in the process of raising, from a liquid resin, a platform 260 on which the formed object 254 is formed. Furthermore, when a formed object 255 in FIG. 4C is manufactured by the DLP manufacturing device 2, a large number of support members 220 are required in the spaces of a mesh structure. The formed object 255 itself is manufacturable by the DLP manufacturing device 2; however, when the ratio of support members 220 is high, an excess amount of material is required, and failure of removal of the support members 220 provided inside the formed object may impair the function of the formed object. For example, when the support members 220 cannot be removed, the formed object 255 having a weight higher than the designed weight is manufactured. In addition, an unremovable support member 220 may adversely affect the functionality of the formed object 255. Thus, when an unremovable support member 220 reduces the functionality of the formed object 255 by a predetermined ratio (e.g., 10%), the formed object 255 is determined to have an unmanufacturable shape. Furthermore, even when the support members 220 can be removed from the formed object, removal of the support members 220 is required to manufacture the formed object. For example, when the ratio of the support members 220 removed after manufacturing of the formed object 255 to the formed object 255 exceeds a predetermined value (e.g., 30%), the formed object 255 is determined to have an unmanufacturable shape. The predetermined ratio and the predetermined value are criteria to determine that the formed object 255 that requires a support member 220 is unmanufacturable.

In this manner, the unmanufacturable manufacturing condition under which no formed object is manufacturable is predetermined according to the formation method of the manufacturing device 2, and information on the unmanufacturable manufacturing condition is stored in the manufacturing evaluation database 133 for each formation method of the manufacturing device 2. When the design-support device 1 receives the device information 100 including information on the formation method of the manufacturing device 2, the design-support device 1 reads, from the manufacturing evaluation database 133, information on the unmanufacturable manufacturing condition corresponding to the received formation method of the manufacturing device 2. In the case where the design-support device 1 does not include the manufacturing evaluation database 133 or the manufacturing evaluation database 133 does not store information on the unmanufacturable manufacturing condition corresponding to the formation method of the manufacturing device 2, the design-support device 1 may receive the device information 100 including information on the formation method of the manufacturing device 2 and information on the unmanufacturable manufacturing condition.

The information on the unmanufacturable manufacturing condition that is the unmanufacturable shapes illustrated in FIGS. 3A-3C and 4A-4C is treated, for example, as a shape pattern, and is stored as three-dimensional image information in the manufacturing evaluation database 133. As a matter of course, the information on the unmanufacturable manufacturing condition is not limited to three-dimensional image information, and may be information on a numerical expression or a numerical value. The information on the unmanufacturable manufacturing condition is treated as a shape pattern; thus, as described below, in the footwear item shape data 200, the degree of similarity of a region whose shape pattern has a high degree of similarity to the information on the unmanufacturable manufacturing condition can be evaluated as the degree of similarity in three-dimensional image information, making it possible to easily identify the region. In this manner, the manufacturing evaluation database 133 stores a shape pattern (three-dimensional image information) as information on the unmanufacturable manufacturing condition for each formation method of the manufacturing device 2, thus making it possible to identify shapes unmanufacturable by the manufacturing device 2 of various formation methods. In the above description, the manufacturing evaluation database 133 is stored in the storage 13 of the design-support device 1; however, the manufacturing evaluation database 133 may be stored in a server or ground other than the storage 13.

### Process Performed by Design-Support Device

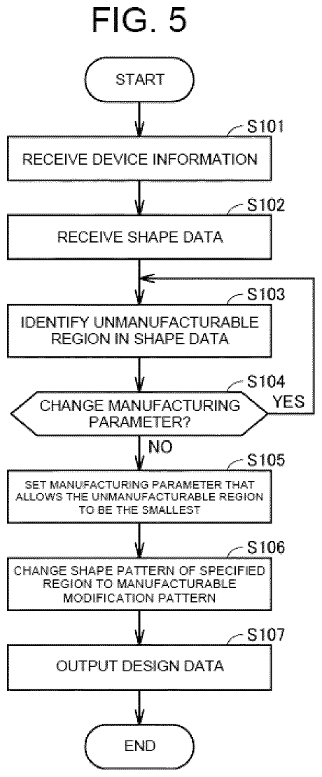

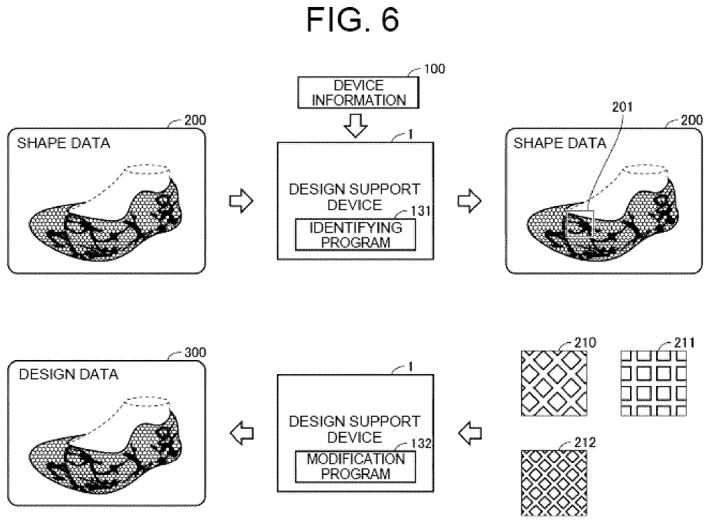

Next, the following will describe in detail a process in which the design-support device 1 executes the identifying program 131 and the modification program 132 to create, from the shape data 200, design data that enables a formed object to be manufactured by the manufacturing device 2. FIG. 5 is a flowchart illustrating a process performed by the design-support device 1 according to Embodiment 1. FIG. 6 is a schematic diagram illustrating the process performed by the design-support device 1 according to Embodiment 1. First, the design-support device 1 receives the device information 100 including information on the formation method of the manufacturing device 2 (step S101). Then, the design-support device 1 receives the footwear item shape data 200 (step S102).

The design-support device 1 identifies an unmanufacturable region in the shape data 200 (step S103). Specifically, the design-support device 1 reads, from the device information 100 received in step S101, an unmanufacturable shape pattern (information on the manufacturing condition) stored in the manufacturing evaluation database 133. The design-support device 1 compares the shape pattern in the footwear item shape data 200 with the unmanufacturable shape pattern, and evaluates the degree of similarity between the shape patterns. The design-support device 1 can use a known algorithm for evaluating the difference or the degree of similarity in three-dimensional image information as an algorithm for evaluating the degree of similarity to the shape pattern, and may further use a method using a neural network, or the like.

As illustrated in FIG. 6, the design-support device 1 executes the identifying program 131 to identify an unmanufacturable region 201 (first region) in the footwear item shape data 200. The unmanufacturable region 201 varies depending on a manufacturing parameter for manufacturing a footwear item by the manufacturing device 2. For example, when the manufacturing parameter is the direction in which a footwear item is manufactured, the unmanufacturable region 201 varies depending on from which side of the footwear item, the toe side or the heel side, the footwear item is manufactured. Thus, the design-support device 1 determines whether a manufacturing parameter (formation direction) to be varied is present (step S104). The design-support device 1 identifies the unmanufacturable region 201 in the case where a footwear item is manufactured from the toe side. Then, the design-support device 1 identifies again the unmanufacturable region 201 in the case where the footwear item is manufactured from the heel side. That is, when the manufacturing parameter (formation direction) to be varied is present (YES in step S104), the process returns to step S103 and the design-support device 1 identifies again the unmanufacturable region 201.

On the other hand, when no manufacturing parameter (formation direction) to be varied is present (No in step S104), the design-support device 1 sets a manufacturing parameter that allows the unmanufacturable region 201 to be the smallest (step S105). The design-support device 1 compares the size of the unmanufacturable region 201 identified in the case where the footwear item is manufactured from the toe side with the size of the unmanufacturable region 201 identified in the case where the footwear item is manufactured from the heel side, and sets, as a manufacturing parameter for the manufacturing device 2, a manufacturing parameter that allows the unmanufacturable region 201 to be smaller. The design-support device 1 adds information on the set manufacturing parameter to design data, and outputs the design data to the manufacturing device 2.

In manufacturing of a symmetrically formed object, even if the formation direction is varied, the shape of a manufactured formed object is not varied; thus, the design-support device 1 determines in step S104 that no manufacturing parameter to be varied is present. Furthermore, when the formation direction is fixed due to other limitations, the design-support device 1 also determines in step S104 that no manufacturing parameter to be varied is present. Furthermore, in the above description, the formation direction is set as an example of the manufacturing parameter; however, a manufacturing time, material, or the like may be set as a manufacturing parameter.

When a footwear item is manufactured as a formed object, the material of the footwear item is preferably a resin material or a rubber material so that the footwear item has suitable flexibility, extensibility, durability, elastic force, and the like. More specifically, when the footwear item is made of resin, the material of the footwear item may be, for example, polyolefin resin, ethylene-vinyl acetate copolymer (EVA), thermoplastic polyamide elastomer (TPA, TPAE), thermoplastic polyurethane (TPU), or thermoplastic polyester elastomer (TPEE). In particular, a thermoplastic resin is used by the FDM manufacturing device 2, and a thermosetting resin is used by the DLP manufacturing device 2.

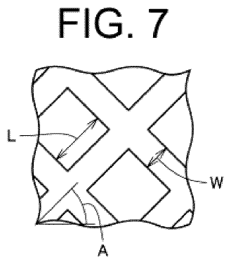

Then, the design-support device 1 changes the shape pattern of the identified unmanufacturable region 201 to a manufacturable modification pattern (step S106). Manufacturable modification patterns are stored in the modification pattern database 134 of the storage 13. The modification pattern database 134 stores a plurality of modification patterns of different types for each formation method of the manufacturing device 2. The modification patterns of different types are different, for example, in at least one of the thickness of lines constituting the patterns, angle between the lines, distance between the lines, and color of the lines. Specifically, FIG. 7 is a schematic diagram illustrating a modification pattern. As illustrated in FIG. 7, the modification pattern database 134 stores a plurality of modification patterns different in thickness W of lines constituting the patterns, distance L between two of the lines, and angle A between two of the lines. In the above description, the modification pattern database 134 is stored in the storage 13 of the design-support device 1; however, the modification pattern database 134 may be stored in a server or ground other than the storage 13. Furthermore, the modification pattern database 134 also includes a manufacturable modification pattern in which a plurality of materials are laminated, a modification pattern in which regions are different in material and color, and the like, and can store a modification pattern including various types of information such as information on materials and colors, in addition to information on the lines.

As illustrated in FIG. 6, the design-support device 1 reads, from the modification pattern database 134, a plurality of modification patterns 210, 211, and 212 corresponding to the formation method of the manufacturing device 2. The design-support device 1 executes the modification program 132 to change the shape pattern of the identified unmanufacturable region 201 to one of the plurality of modification patterns 210, 211, and 212. Specifically, the design-support device 1 selects, from the plurality of modification patterns 210, 211, and 212, a modification pattern that has the highest degree of similarity to the shape pattern of the identified unmanufacturable region 201, and changes the shape pattern of the unmanufacturable region 201 to the selected modification pattern. The design-support device 1 compares the shape pattern of the unmanufacturable region 201 with the plurality of modification patterns, and evaluates the degree of similarity between the patterns. The design-support device 1 can use a known algorithm for evaluating the difference or the degree of similarity in three-dimensional image information as an algorithm for evaluating the degree of similarity to the shape pattern, and may further use a method using a neural network, or the like.

The design-support device 1 changes the shape pattern of the unmanufacturable region 201 in the footwear item shape data 200 to the modification pattern to create the shape data 200 after modification, and then creates design data 300. The design-support device 1 outputs the created design data 300 to the manufacturing device 2 (step S107). In the above description, the design-support device 1 creates the shape data 200 after modification, and then creates the design data 300; however, the design-support device 1 may directly create the design data 300 based on the shape data 200 and the modification pattern, without creating the shape data 200 after modification.

In this manner, the design-support device 1 identifies, in the shape data 200, the unmanufacturable region 201 unmanufacturable by the formation method of the manufacturing device 2, and creates design data by changing the shape pattern of the identified unmanufacturable region 201 to a manufacturable modification pattern. This allows the design-support device 1 to automatically create design data that enables a designed three-dimensional formed object to be manufactured, without reworking of shape data by a designer.

### Embodiment 2

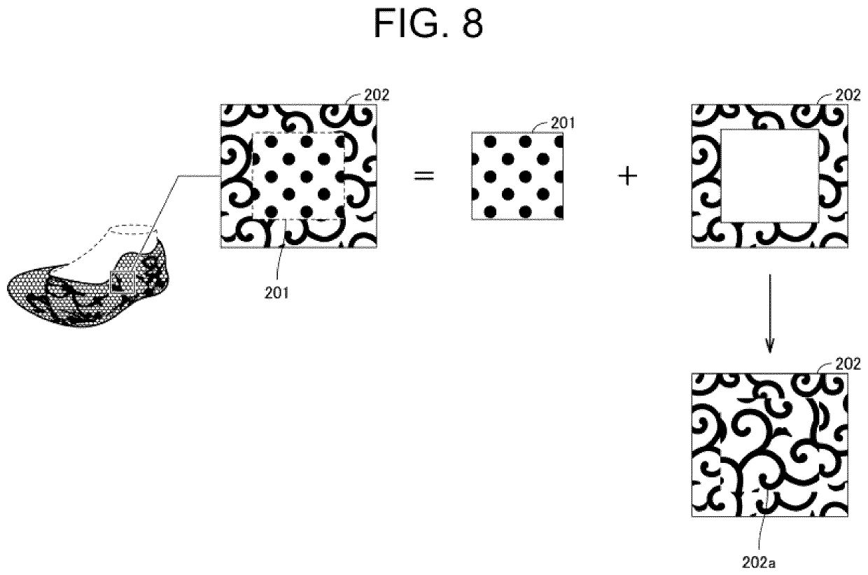

In the embodiment described above, the design-support device 1 selects a modification pattern that has the highest degree of similarity to the shape pattern of the identified unmanufacturable region 201, and changes the shape pattern of the unmanufacturable region 201 to the selected modification pattern. However, the method of selecting a modification pattern to which the shape pattern is changed is not limited to this method. FIG. 8 is a schematic diagram illustrating a process performed by the design-support device 1 according to Embodiment 2. The design-support device 1 according to Embodiment 2 has the same configuration as the design-support device 1 according to Embodiment 1, and detailed description of the configuration is not repeated.

When an unmanufacturable region is identified in the shape data 200 according to the formation method of the manufacturing device 2, the design-support device 1 sets a manufacturable region 202 (second region) around the unmanufacturable region 201. The manufacturable region 202 is a region that is adjacent to the unmanufacturable region 201 and has a predetermined range. As the predetermined range, for example, the range of several centimeters, the range of one unit of repeating pattern, or the like is set in advance.

As illustrated in FIG. 8, the design-support device 1 identifies the unmanufacturable region 201, and sets the manufacturable region 202 around the unmanufacturable region 201. The design-support device 1 reads, from the modification pattern database 134, a modification pattern 202a that has the highest degree of similarity to the shape pattern of the set manufacturable region 202, and changes the shape pattern of the unmanufacturable region 201 using the read modification pattern 202a. The modification pattern 202a that has the highest degree of similarity to the shape pattern of the manufacturable region 202 is used for the unmanufacturable region 201; thus, the manufacturable region 202 and the modification pattern 202a have a highly continuous shape, achieving a less unnatural design.

Furthermore, the design-support device 1 may change the shape pattern of a region close to the boundary between the unmanufacturable region 201 and the manufacturable region 202 to the modification pattern 202a that has the highest degree of similarity to the shape pattern of the manufacturable region 202, and change the shape pattern of a region other than the region close to the boundary using a modification pattern that has the highest degree of similarity to the shape pattern of the unmanufacturable region 201. Thus, the modification pattern is changed in a stepwise manner from the manufacturable region 202 toward the unmanufacturable region 201, achieving an even less unnatural design.

### Modification

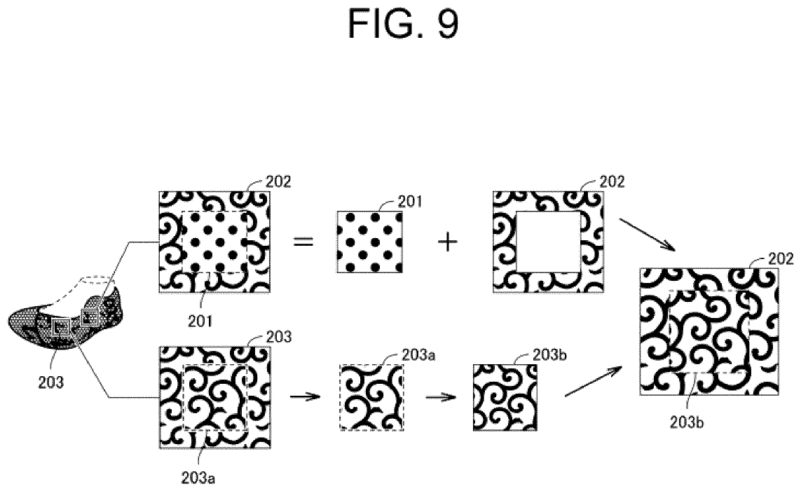

Another method of selecting a modification pattern to which the shape pattern is changed will be described. FIG. 9 is a schematic diagram illustrating a process performed by the design-support device 1 according to a modification. The design-support device 1 according to the modification has the same configuration as the design-support device 1 according to Embodiment 1, and detailed description of the configuration is not repeated.

As illustrated in FIG. 9, the design-support device 1 identifies the unmanufacturable region 201, and sets the manufacturable region 202 around the unmanufacturable region 201. Then, the design-support device 1 selects, from manufacturable regions in the shape data 200, a region whose shape pattern has the highest degree of similarity to the shape pattern of the set manufacturable region 202, and sets the selected region as a similar region 203 (third region). The design-support device 1 reads, from the modification pattern database 134, a modification pattern 203b that has the highest degree of similarity to the shape pattern of a region 203a of the similar region 203 whose size corresponds to the size of the unmanufacturable region 201, and changes the shape pattern of the unmanufacturable region 201 using the read modification pattern 203b. The similar region 203 whose shape pattern has the highest degree of similarity to the shape pattern of the manufacturable region 202 is set as another region, and the modification pattern 203b is selected based on the shape pattern of the region 203a whose size corresponds to the size of the unmanufacturable region 201, thus achieving an even less unnatural design.

### Other Modifications

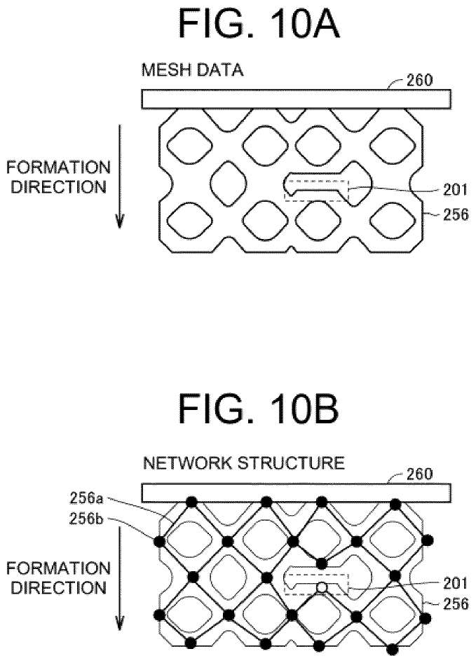

In the embodiment described above, the design-support device 1 compares the shape pattern in the footwear item shape data 200 with the unmanufacturable shape pattern, and evaluates the degree of similarity between the shape patterns to identify the unmanufacturable region 201. However, the method of identifying an unmanufacturable region is not limited to this method. FIGS. 10A and 10B are each a schematic diagram illustrating other methods of identifying an unmanufacturable shape. The design-support device 1 according to a modification has the same configuration as the design-support device 1 according to Embodiment 1, and detailed description of the configuration is not repeated.

FIG. 10A illustrates mesh data for forming a formed object 256 having a three-dimensional lattice structure on the platform 260. The downward direction in FIG. 10A is the formation direction in which the formed object 256 is formed. The formed object 256 has a region in which the lattice structure is not continuous, and the region is the unmanufacturable region 201 unmanufacturable by the manufacturing device 2. When the mesh data is used to identify the unmanufacturable region 201, the design-support device 1 compares a shape pattern obtained from the mesh data with the unmanufacturable shape pattern stored in the manufacturing evaluation database 133, and evaluates the degree of similarity between the shape patterns to identify the unmanufacturable region 201.

In FIG. 10B, the mesh data is converted into data with a network structure having sides 256a and vertices 256b. Based on whether a side 256a connecting two vertices 256b is present, the design-support device 1 can find, in the data with a network structure, a region in which the lattice structure is not continuous, and identify the unmanufacturable region 201. In this manner, the design-support device 1 uses the data with a network structure; thus, as compared with the case where the mesh data is used, a smaller amount of data is processed, leading to less burden in the processing of identifying the unmanufacturable region 201.

### Aspects

(1) A design-support device according to the present disclosure is a design-support device that supports creation of design data to be input to a manufacturing device that manufactures a three-dimensional formed object, the design-support device including: an input unit that receives shape data on the formed object and device information on the manufacturing device;
a processing unit that identifies, in the shape data, based on the device information, a first region of the formed object unmanufacturable by the manufacturing device and creates the design data in which a shape pattern of the first region is modified;
a storage unit that stores a manufacturable modification pattern; and
an output unit that outputs the design data modified by the processing unit, wherein the processing unit
creates the design data by changing the shape pattern of the first region to the modification pattern.

This allows the design-support device to automatically create design data that enables a designed three-dimensional formed object to be manufactured, without reworking of shape data by a designer.

(2) In the design-support device according to (1), the storage unit stores a plurality of the modification patterns of different types, and the processing unit changes the shape pattern of the first region to one of the plurality of modification patterns stored in the storage unit that has a highest degree of similarity to the shape pattern of the first region.

This allows the design-support device to automatically create design data that enables a three-dimensional formed object to be manufactured, without impairment of the design quality of shape data by a designer.

(3) In the design-support device according to (2), the plurality of modification patterns stored in the storage unit are different in at least one of a thickness of lines constituting the patterns, an angle between the lines, a distance between the lines, and a color of the lines.

This allows the design-support device to prepare a plurality of modification patterns different in at least one of the thickness of lines constituting the patterns, angle between the lines, distance between the lines, and color of the lines.

(4) In the design-support device according to (2) or (3), the processing unit sets a manufacturable second region around the first region, reads, from the storage unit, one of the modification patterns that has a highest degree of similarity to a shape pattern of the second region, and changes the shape pattern of the first region using the one of the modification patterns retrieve from the storage unit.

This allows the design-support device to automatically create design data that enables a three-dimensional formed object to be manufactured, without impairment of the design quality of the first region and the second region set around the first region.

(5) In the design-support device according to (4), the processing unit sets, in the shape data, a third region whose shape pattern has a highest degree of similarity to the shape pattern of the second region, reads, from the storage unit, one of the modification patterns that has a highest degree of similarity to the shape pattern of the third region, and changes the shape pattern of the first region using the one of the modification patterns retrieve from the storage unit.

This allows the design-support device to automatically create design data that enables a three-dimensional formed object to be manufactured, further preventing impairment of the design quality of the first region and the second region.

(6) In the design-support device according to any one of (1) to (5), the design data includes a manufacturing parameter for manufacturing the formed object by the manufacturing device, and the processing unit identifies the first region by changing the manufacturing parameter, and sets the manufacturing parameter that allows the first region to be smallest.

This allows the design-support device to have a smaller region modified using the modification pattern.

(7) In the design-support device according to any one of (1) to (6), the device information includes at least information on a formation method of the manufacturing device and information on a manufacturing condition under which no formed object is manufacturable by the formation method.

This allows the design-support device to automatically create design data that enables a three-dimensional formed object to be manufactured, without storing information on the formation method of the manufacturing device or information on the manufacturing condition under which no formed object is manufacturable by the formation method.

(8) In the design-support device according to any one of (1) to (7), the storage unit stores, for each formation method of the manufacturing device, information on a manufacturing condition under which no formed object is manufacturable, the device information received by the input unit includes at least information on a formation method of the manufacturing device, and the processing unit reads, from the storage unit, based on the device information, information on the manufacturing condition.

This allows the design-support device to read, from the storage unit, information on the manufacturing condition according to the formation method of the manufacturing device.

(9) In the design-support device according to (7) or (8), the information on the manufacturing condition includes a criterion to determine that the formed object that requires a support member is unmanufacturable.

This allows the design-support device to automatically create, even for a formed object that requires a support member, design data modified using the modification pattern.

(10) In the design-support device according to any one of (1) to (9), the formed object is an item worn by a user.

This allows the design-support device to automatically create, for an item worn by a user, design data that enables a designed three-dimensional formed object to be manufactured.

(11) A design-support method according to the present disclosure is a design-support method of supporting creation of design data to be input to a manufacturing device that manufactures a three-dimensional formed object, the design-support method including:
receiving shape data on the formed object and device information on the manufacturing device;
identifying, in the shape data, based on the device information, a first region of the formed object unmanufacturable by the manufacturing device;
creating the design data by changing, to a manufacturable modification pattern, the shape data on the first region identified; and
outputting the design data created.

This allows the design-support method to automatically create design data that enables a designed three-dimensional formed object to be manufactured, without reworking of shape data by a designer.

(12) A recording medium recording a program according to the present disclosure is a non-transitory recording medium recording a program executed by a processing unit of a design-support device that supports creation of design data to be input to a manufacturing device that manufactures a three-dimensional formed object, the program including:
receiving, by an input unit, shape data on the formed object and device information on the manufacturing device;
identifying, in the shape data, based on the device information, a first region of the formed object unmanufacturable by the manufacturing device;
creating the design data by changing, to a manufacturable modification pattern stored in a storage unit, the shape data on the first region identified; and
outputting, from an output unit, the design data created.

This allows the program to automatically create design data that enables a designed three-dimensional formed object to be manufactured, without reworking of shape data by a designer.

The embodiments disclosed herein should be construed as illustrative in all respects and not as restrictive. The scope of the present invention is defined not by the above description but by the claims, and is intended to include all modifications within the meaning and scope equivalent to the claims.

What is claimed is:

1. A design-support device that supports creation of design data to be input to a manufacturing device that is configured to manufacture a three-dimensional formed object, the design-support device comprising:
an input unit that receives shape data on the formed object and device information on the manufacturing device;
a processing unit that identifies, in the shape data, based on the device information, a first region of the formed object unmanufacturable by the manufacturing device and creates the design data with a modified shape pattern of the first region;
a storage unit that stores a manufacturable modification pattern; and
an output unit that outputs the design data modified by the processing unit to the manufacturing device, wherein
the processing unit creates the design data by changing the shape pattern of the first region to the modification pattern.

2. The design-support device according to claim 1, wherein
the storage unit stores a plurality of the modification patterns of different types, and
the processing unit changes the shape pattern of the first region to one of the plurality of modification patterns stored in the storage unit that has a highest degree of similarity to the shape pattern of the first region.

3. The design-support device according to claim 2, wherein
the plurality of modification patterns stored in the storage unit are different in at least one of a thickness of lines constituting the patterns, an angle between the lines, a distance between the lines, and a color of the lines.

4. The design-support device according to claim 2, wherein
the processing unit sets a manufacturable second region around the first region, retrieves from the storage unit, one of the modification patterns that has a highest degree of similarity to a shape pattern of the second region, and changes the shape pattern of the first region using the one of the modification patterns retrieve from the storage unit.

5. The design-support device according to claim 4, wherein
the processing unit sets, in the shape data, a third region whose shape pattern has a highest degree of similarity to the shape pattern of the second region, retrieves from the storage unit, one of the modification patterns that has a highest degree of similarity to the shape pattern of the third region, and changes the shape pattern of the first region using the one of the modification patterns retrieve from the storage unit.

6. The design-support device according to claim 1, wherein
the design data includes a manufacturing parameter for manufacturing the formed object by the manufacturing device, and
the processing unit identifies the first region by changing the manufacturing parameter, and sets the manufacturing parameter that makes the first region to be smallest.

7. The design-support device according to claim 1, wherein
the device information includes at least information on a formation method of the manufacturing device and information on a manufacturing condition that unmanufacturable by the formation method.

8. The design-support device according to claim 1, wherein
the storage unit stores information on a manufacturing condition that unmanufacturable for each formation method of the manufacturing device,
the device information received by the input unit includes at least information on a formation method of the manufacturing device, and
the processing unit retrieves information on the manufacturing condition from the storage unit, based on the device information.

9. The design-support device according to claim 7, wherein
the information on the manufacturing condition includes a criterion to determine that the formed object unmanufacturable that requires a support member.

10. The design-support device according to claim 1, wherein
the formed object is an item worn by a user.

11. A design-support method of supporting creation of design data to be input to a manufacturing device that is configured to manufacture a three-dimensional formed object, the design-support method comprising:
receiving shape data on the formed object and device information related to the manufacturing device;
identifying the shape data, based on the device information, a first region of the formed object unmanufacturable by the manufacturing device;
creating the design data by changing, the shape data on the first region identified to a manufacturable modified pattern; and
outputting the created design data to the manufacturing device.

12. A non-transitory storage medium storing a program executed by a processing unit of a design-support device that supports creation of design data to be input to a manufacturing device that is configured to manufacture a three-dimensional formed object, the program causing the processing unit to perform operations comprising:
receiving, by an input unit, shape data on the formed object and device information on the manufacturing device;
identifying, in the shape data, based on the device information, a first region of the formed object unmanufacturable by the manufacturing device;
creating the design data by changing, to a manufacturable modification pattern stored in a storage unit, the shape data on the first region identified; and
outputting, from an output unit, the created design data to the manufacturing device.
